(19) United States
(12) Patent Application Publication
(10) Pub. No.: US 2020/0339807 A1
(43) Pub. Date: Oct. 29, 2020

(54) RAPID GEL POLYMERICCOMPOSITIONS, SYSTEMS AND METHODS

(71) Applicant: 3V Sigma USA Inc., Georgetown, SC (US)

(72) Inventors: Paolo Vigilante, Pawleys Island, SC (US); PASQUALINO ARAMO, Scotch Plains, NJ (US); GIORGIO ZANCHI, Summerville, SC (US)

(21) Appl. No.: 16/858,090

(22) Filed: Apr. 24, 2020

Related U.S. Application Data
(60) Provisional application No. 62/839,068, filed on Apr. 26, 2019.

(51) Int. Cl. C08L 71/02

(52) U.S. Cl. CPC C08L 71/02

(57) ABSTRACT

A rapid gel composition including a mixture for achieving rapid homogenous dispersion having: a) crosslinked or non-crosslinked acrylic acid homopolymers or copolymers component, b) suitable solvent component and c) a suitable organic or inorganic base component.

### CROSS-REFERENCE TO RELATED APPLICATIONS

This application is a non-provisional U.S. patent application, which claims priority under 35 U.S.C. § 119 to U.S. Provisional Patent Application No. 62/839,068, filed Apr. 26, 2019, the entirety incorporated by reference herein.

### FIELD

This disclosure is generally related to a rapid gel composition of mixtures of acrylic acid homopolymers, acrylic acid copolymers with other olefinically unsaturated carboxylic acids and/or other vinyl monomers, and/or acrylate esters, and/or metacrylate esters, with an organic liquid solvent and a neutralizing media. The suspension obtained is easily wettable in water and easily solvated in solvents.

### BACKGROUND

Polycarboxylic polymers are known to the prior art. They may be homopolymers of acrylic acid, copolymers of acrylic acid with methacrylic, itaconic, maleic or crotonic acid, copolymers of acrylic acid with methyl, ethyl, propyl or higher esters up to C18-22 of acrylic acid or of methacrylic, itaconic, maleic or crotonic acids, copolymers with other monomers containing a vinyl unsaturation, such as the vinyl esters of linear or branched acids up to C18-20, vinyl esters, and styrene. Some of these polymers are used in the cosmetic industry under the INCI name of “carbomer.”

The homo- and copolymers described above can also be cross-linked with small amounts of ethylenically unsaturated multifunctional monomers such as the allyl ethers of pentaerythritol, trimethylolpropane or sugars. These are usually prepared by polymerization in a suitable organic solvent, at atmospheric pressure or a higher pressure in a closed autoclave, using catalysts able to generate free radicals such as peroxides, organic hydroperoxides and azo compounds.

The polymers thus prepared precipitate in the reaction solvent in the form of solid aggregated particles, which are separated from the solvent by filtration and/or direct drying. The powders thus obtained are used as viscosity-controlling agents for aqueous media because they develop very high viscosities after neutralization. However, these powders can be difficult to disperse in water, and sometimes develop an undesirably high viscosity even before neutralization.

Synthesis processes in the presence of surfactants, generally non-ionic, with hydrophobic-lipophilic balance (HLB) values of between 1 and 12, have purported to eliminate these drawbacks. See, for example, U.S. Pat. Nos. 4,375,533, 4,419,502 and 4,420,596.

Interpolymers containing “steric stabilizers,” including surfactants constituted by linear block copolymers with the hydrophobic part not less than 50 Angstroms long, or randomly distributed “comb” copolymers, were disclosed in U.S. Pat. No. 5,288,814. Such steric stabilizers are copolymerized with acrylic monomers, and integrated into the polymer chains after polymerization.

U.S. Pat. No. 7,560,423 utilizes a combination of inorganic compounds as sodium chloride in mixture with silicone surfactant to obtain in shorter times the homogeneous dispersion in water of the polycarboxylic polymers.

The above disclosures still require significant time to disperse the polymers in water or in a solvent. At least 1 hour is required to obtain industrially homogeneous dispersions in water, followed by at least 2 hours to neutralize the polymers obtaining the rheology desired. This amount of time is not desirable in continuous industrial productions.

Furthermore, in the manufacturing of the emulsions, like lotions and creams, the dispersion of the polymeric emulsifier in water or oil phase is subject to the same burden of operations and required time of the water dispersion of gels.

Accordingly, there remains a need for a more expedient dispersion technology that results in homogeneous dispersions with satisfactory viscosity.

### SUMMARY OF THE INVENTION

In an aspect, rapid gel polymeric compositions and methods for a faster way to obtain a homogeneous dispersion in water or in a solvent with the desired viscosity, referred to herein as “rapid gel,” are disclosed. In some embodiments, a rapid gel polymeric composition of a dispersion of polymers or copolymers in organic solvents in the presence of a base does not require neutralization. In some embodiments, a rapid gel polymeric composition of a dispersion of polymers or copolymers in organic solvents in the presence of a base only requires minutes, and much less than an hour to obtain a product having the consistency of a gel, cream, or lotion with desired viscosity. The liquid form coupled with a fast dispersion time and absence of neutralization step are favorable features to industrial continuous production.

In some embodiments, a mixture, in suspension form, is disclosed having the following components: a) homopolymers of acrylic acid, copolymers of acrylic acid with methacrylic, itaconic, maleic or crotonic acid, copolymers of acrylic acid with methyl, ethyl, propyl or higher esters up to C18-22, quaternary ammonium salt, and/or cationic branched alkyl of acrylic acid or of methacrylic, itaconic, maleic or crotonic acids, copolymers with other monomers containing a vinyl unsaturation, such as the vinyl esters of linear or branched acids up to C18-22, vinyl esters and styrene, possibly crosslinked with small amounts of ethylenically unsaturated multifunctional monomers such as the allyl ethers of pentaerythritol, trimethylolpropane or sugars, with; b) an organic solvent, and; c) an organic or inorganic base. Suspensions obtained from the combination of these three components tend to be stable, easy to handle, have low viscosity, are not dusty and are more readily dispersible in water and/or oils than other polymers alone that are known in the the art.

In some embodiments, rapid gel polymeric compositions are disclosed for ready dispersion and to achieve a certain viscosity in a final product. In some embodiments, a neutralization step is not required to prepare a rapid gel polymeric composition suspension, as the suspension is already pre-neutralized. In some embodiments, the time of dispersion is reduced to few minutes versus several hours. In some embodiments, the rapid gel polymeric composition has a polymer with a greater hydration speed. In some embodiments, the rapid gel polymeric composition is able to create a stable emulsion in hot or cold processing in shorter period of time.

In another aspect, methods of preparing rapid gel polymeric compositions for use in forming dispersions are disclosed. In some embodiments, the methods for preparing such compositions include the steps of: 1) dissolving a monomer or mixture of monomers, and the crosslinkers, if any, in a suitable organic solvent, such as methylene chloride, benzene, low-boiling aliphatic hydro-carbons such as hexane or cyclohexane, lower esters such as methyl or ethyl acetate or mixtures of said solvents; 2) adding polymerization initiators such as lauroyl peroxide, dicetyl peroxydicarbonate, benzoyl peroxide, or other peroxides; 3) heating at ambient pressure and at the temperature required by the nature of the monomers and polymerization initiators used, or at a pressure exceeding ambient pressure in a closed reactor, until polymerization is complete; 4) evaporating the solvent until dry to obtain the polymer in the form of a fine powder easily dispersible in water. In some embodiments, the polymer is first separated from the solvent by direct evaporation of the solvent or by filtration of the solvent and subsequent drying.

Other aspects and advantages of the invention will become apparent from a review of the detailed description below.

### DETAILED DESCRIPTION

Embodiments described herein can be understood more readily by reference to the following detailed description, and examples. Elements, apparatus and methods described herein, however, are not limited to the specific embodiments presented in the detailed description, examples, and drawings. It should be recognized that these embodiments are merely illustrative of the principles of this disclosure. Numerous modifications and adaptations will be readily apparent to those of skill in the art without departing from the spirit and scope of this disclosure

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9

All ranges disclosed herein are also to be considered to include the end points of the range, unless expressly stated otherwise. For example, a range of “between 5 and 10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

All wt. % quantities are based on a total weight of the composition unless expressly stated otherwise.

According to its major aspects and briefly described, rapid gel polymeric compositions disclosed herein can readily form dispersions having a desired viscosity, also referred to herein as rapid gels.

In an aspect, rapid gel polymeric compositions for forming ready dispersions include polymers or copolymers in organic solvents in the presence of a base are described. In one embodiment, a composition includes a mixture, in suspension form, has the following components: a) homopolymers of acrylic acid, copolymers of acrylic acid with methacrylic, itaconic, maleic or crotonic acid, copolymers of acrylic acid with methyl, ethyl, propyl or higher esters up to C18-22, quaternary ammonium salt, and/or cationic branched alkyl of acrylic acid or of methacrylic, itaconic, maleic or crotonic acids, copolymers with other monomers containing a vinyl unsaturation, such as the vinyl esters of linear or branched acids up to C18-22, vinyl esters and styrene, optionally crosslinked with ethylenically unsaturated multifunctional monomers such as the allyl ethers of pentaerythritol, trimethylolpropane or sugars, with; b) an organic solvent, and; c) an organic or inorganic base.

In another aspect, methods for forming rapid gel polymeric compositions such as above are described. In one embodiment, the crosslinked or non-crosslinked acrylic acid homopolymers or copolymers of component a) of the mixture are can be prepared with the following steps: 1) dissolving the monomer or mixture of monomers, and the crosslinkers, if any, in an organic solvent, such as methylene chloride, benzene, low-boiling aliphatic hydro-carbons such as hexane or cyclohexane, lower esters such as methyl or ethyl acetate or mixtures of these solvents; 2) adding polymerization initiators such as lauroyl peroxide, dicetyl peroxydicarbonate, benzoyl peroxide, or other peroxides; 3) heating at ambient pressure and at the temperature required by the nature of the monomers and polymerization initiators used, or at a pressure exceeding ambient pressure in a closed reactor, until polymerization is complete; and 4) evaporating the solvent until dry to obtain the polymer in the form of a fine powder easily dispersible in water. The polymer is first separated from the solvent by direct evaporation of the solvent or by filtration of the solvent and subsequent drying.

In one embodiment a suitable solvent component b) can be an organic solvent readily soluble in water. A preferred solvent is in the polyalkylene glycols family, and in particular the PEG at low molecular weight, such as PEG300.

In another embodiment, solvent component b) can be an organic ester, natural and mineral oils, polyglyceril-fatty acid ester derivative, glyceril-esters, triglycerides esters not soluble or soluble in water. Examples of esters include without limitation: butyloleate, isopropylmyristate, isononyl isononanoate, octyldodecanol, octylpalmitate, octyldodecyl myristate, C12-C15 alkyl benzoate, cetearyl isononanoate, cetearyl ethylhexanoate, dibutyl adipate, isodecyloleate, or decyl oleate. Examples of mineral/natural oils include without limitation: mineral oil (petrolatum), hydrogenated paraffines tall oil fatty acid (TOFA), PAG (poly-alkyl glycols), or PAO (poly-alpha olefins). Examples of polyglyceril-fatty acid ester derivative include without limitation: polyglyceryl-4 stearate, or polyglyceryl-6 laurate, polyglyceryl-6 oleate. Examples of glyceril-esters include without limitation: PEG-6 caprylic/capric glycerides, PEG-7 glyceryl cocoate, coco-caprylate/caprate; propylene glycol dicaprylate-dicaprate, or caprylic/capric triglyceride. Examples of polyalcohol esters include without limitation: trimethylolpropane triisostearate, pentaerythrityl tetraisostearate. Examples of liquid fatty alcohols include without limitation: heptanol, octanol, nonanol, or decanol. Preferred solvents include coco-caprylate/caprate, caprylic/capric trigligeride, trimethylolpropane triisostearate, pentaerythrityl tetraisostearate, or propylene glycol dicaprylate-dicaprate,

In one embodiment, a suitable organic or inorganic base component c) includes an inorganic base like NaOH or KOH. In one embodiment, a base component c) can be an organic base like monoethanol amine (MEA), dietahnol amine (DEA), triethanol amine (TEA), 2-amino-2-methyl-1-propanol (AMP), ammonia, or Tris(hydroxymethyl)aminomethane. A preferred base includes AMP.

Although other ratios of the components are contemplated depending on the application or circumstances, in one embodiment, the crosslinked or non-crosslinked acrylic acid homopolymers or copolymers component a) is present at 10% to 70% w/w. In another embodiment, the crosslinked or non-crosslinked acrylic acid homopolymers or copolymers component a) is present at 10% to 50% w/w. In another embodiment, the crosslinked or non-crosslinked acrylic acid homopolymers or copolymers component a) is present at 20% to 50% w/w. In another embodiment, the crosslinked or non-crosslinked acrylic acid homopolymers or copolymers component a) is present at 10% to 20% w/w. In another embodiment, the crosslinked or non-crosslinked acrylic acid homopolymers or copolymers component a) is present at 13% to 14% w/w.

Some embodiments described herein are further illustrated in the following non-limiting examples.

### Example 1

### Preparation of a Rapid Gel Polymeric Composition

In one example, a rapid gel polymeric composition was formed with 73.18 g of acrylic acid, 5.94 g vinyl neodecanoate, 0.52 g of pentaerythritol triallyl ether and 7.07 g of bis-(myristyl)-peroxydicarbonate dissolved in 790 g of methylene chloride. The solution was cascade heated refluxed under nitrogen for 12 hours. The final copolymer dispersion obtained was then isolated by distillation in a rotary evaporator at low pressure, and 82.6 g of copolymer in the form of a white powder is obtained. Next, 50 g of this copolymer was thoroughly mixed with 291 g of PEG 300 and 17 g of AMP. The suspension obtained had a polymer content of 13.97% w/w.

### Example 2

### Preparation of Example 1 without the Preparation of the Rapid Gel

In another example, a polymeric composition was formed with 73.18 g of acrylic acid, 5.94 g vinyl neodecanoate, 0.52 g of pentaerythritol triallyl ether and 7.07 g of bis-(myristyl)-peroxydicarbonate dissolved in 790 g of methylene chloride. The solution was cascade heated refluxed under nitrogen for 12 hours. The final copolymer dispersion obtained was then isolated by distillation in a rotary evaporator at low pressure, and 82.6 g of copolymer in the form of a white powder was obtained. Powder form with copolymer content of 100% w/w.

### Example 3

### Preparation of a Rapid Gel Polymeric Composition with Known Polymer Component

In still another example, a polymer component was formed with 50 g of an acrylic acid/stearyl acrylate copolymer (INCI name: Acrylates/C10-30 alkyl acrylate crosspolymer) using the method described in U.S. Pat. No. 5,288,814. This polymer component was thoroughly mixed with 291 g of PEG 300 and 17 g of AMP. The suspension obtained has a polymer content of 13.97% w/w.

### Example 4

### Preparation of Example 3 without the Preparation of a Rapid Gel

In yet another example, a polymer component was formed with 50 g of an acrylic acid/stearyl acrylate copolymer (INCI name: Acrylates/C10-30 alkyl acrylate crosspolymer) as prepared in U.S. Pat. No. 5,288,814. A powder formed with polymer content of 100% w/w.

### Example 5

### Preparation of a Rapid Gel Polymeric Composition with Known Polymer Component

In another example, a polymer was prepared according to U.S. Pat. No. 7,560,423. Specifically, 79.12 g of acrylic acid, 0.88 g of pentaerythritol triallyl ether and 0.60 g of bis-(ter-butyl-cyclohexyl)-peroxydicarbonate were dissolved in 790 g of methylene chloride. The solution was cascade heated refluxed under nitrogen for 12 hours. Then 1.60 g of finely ground sodium chloride (<100 microns), and 0.4 g of a surfactant consisting of heptamethyltrisiloxane grafted with polyoxymethylene chains constituting 40% of the total weight of the surfactant, were added under agitation to the fine dispersion of polyacrylic acid thus obtained. The solvent was then removed by distillation in a rotary evaporator at low pressure, and 82.6 g of crosslinked polyacrylic acid in the form of a white powder was obtained. Next, 50 g of this crosslinked polyacrylic acid (according to U.S. Pat. No. 7,560,423) was thoroughly mixed with 291 g of PEG 300 and 17 g of AMP. The suspension obtained had a polymer content of 13.97% w/w.

### Example 6

### Preparation of Example 5 without the Preparation of a Rapid Gel

In still another example, a polymer is prepared according to U.S. Pat. No. 7,560,423. Specifically, 79.12 g of acrylic acid, 0.88 g of pentaerythritol triallyl ether and 0.60 g of bis-(ter-butyl-cyclohexyl)-peroxydicarbonate were dissolved in 790 g of methylene chloride. The solution was cascade heated refluxed under nitrogen for 12 hours. Then 1.60 g of finely ground sodium chloride (<100 microns), and 0.4 g of a surfactant consisting of heptameth-yltrisiloxane grafted with polyoxymethylene chains constituting 40% of the total weight of the surfactant, were added under agitation to the fine dispersion of polyacrylic acid thus obtained. The solvent was then removed by distillation in a rotary evaporator at low pressure, and 82.6 g of crosslinked polyacrylic acid in the form of a white powder was obtained.

### Example 7

### Preparation of a Rapid Gel Polymeric Composition

In another example, 40 g of the polymer component as described in Example 2 above was thoroughly mixed with 300 g of PEG 300 and 17 g of AMP. The suspension obtained had a polymer content of 11.20% w/w.

### Example 8

### Preparation of Cream Product

In still another example, a rapid gel polymeric composition was made by thoroughly mixing 40 g of the polymer component as described in Example 2 above with 200 g of 1-octanol and 15 g of AMP. The suspension obtained had a polymer content of 15.68% w/w. Next, a simple cold processed cream was prepared by combining 85.5 g of water, 10 g of avocado oil, and 2 g of cyclomethicone in a beaker, under shear of a Silverson at 4000 rpm. Further, 2.5 g of the composition obtained in this example was added during the shearing over the span of 4 minutes.

### Example 9

### Preparation of Cream Product

In another example, a polymeric composition was made by thoroughly mixing 30 g of the polymer component as described in Example 4 above with 170 g of butyloleate and 9 g of AMP. The suspension obtained had a polymer content of 14.35% w/w. Next, a simple cold processed cream was prepared by combining 85.5 g of water, 10 g of avocado oil, and 2 g of cyclomethicone in a beaker, under shear of a Silverson at 4000 rpm. Further, 2.5 g of the composition obtained in this example was added during the shearing over the span of 4 minutes.

### Example 10

### Preparation of Cream Product

A simple cold processed cream was prepared by combining 85.5 g of water and 0.36 g of the composition obtained in Example 2 above in a beaker. The polymer component in this mixture was left to hydrate for 2 hrs under agitation. Then 10 g of avocado oil and 2 g of cyclomethicone were added, under shear of a Silverson at 4000 rpm. Also, 9 g of AMP was added to neutralize the polymer. Additional shearing was done for 4 minutes.

### Example 11

### Preparation of Cream Product

A simple cold processed cream was prepared by combining 85.5 g of water and 0.36 g of the composition obtained in Example 4 above in a beaker. The polymer component was left to hydrate for 2 hrs under agitation. Then 10 g of avocado oil and 2 g of cyclomethicone were added under shear of a Silverson at 4000 rpm. Also, 9 g of AMP was added to neutralize the polymer. Additional shearing was done for 4 minutes.

### Efficacy Tests

Seven of the polymeric compositions described in the above examples (Example 1 through Example 7) were compared, and the hydration time was evaluated in water loading 0.3% w/w of polymer or copolymer. “Hydration time” refers to the time taken for the polymer or copolymer powder and the polymer or copolymer dispersion to be homogeneously hydrated with zero polymer particles not dispersed in water, by placing 5 g for example no. 1, 3 and 5 into 200 ml of water in a 250 ml beaker with agitation, and by placing 0.7 g for example no. 2, 4 and 6 into 200 ml of water in a 250 ml beaker with agitation.

TABLE 1
Comparison of Hydration Times of Example 1 through Example 7

| | | Polymer | | |
|---|---|---|---|---|
| | Sample | Copolymer at | Water | Hydration |
| Example No. | grams | 100% grams | grams | time Minutes |
| 1 | 5 | 0.7 | 200 | 2 |
| 2 | 0.7 | 0.7 | 200 | 240 |
| 3 | 5 | 0.7 | 200 | 3 |
| 4 | 0.7 | 0.7 | 200 | 60 |
| 5 | 5 | 0.7 | 200 | 3 |
| 6 | 0.7 | 0.7 | 200 | 65 |
| 7 | 5 | 0.56 | 200 | 2 |

Four of the polymeric compositions described in the above examples (Example 8 through Example 11) were compared, and the “lotion preparation time” was evaluated. “Lotion preparation time” refers to the time taken to prepare the lotion with the proper hydration time of the polymers.

TABLE 2
Comparison of Lotion Preparation Time
of Example 8 through Example 11

| | | Polymer | | |
|---|---|---|---|---|
| | Sample | Copolymer at | Lotion | Hydration |
| Example No. | grams | 100% grams | grams | time Minutes |
| 8 | 2.5 | 0.39 | 100 | 4 |
| 9 | 2.5 | 0.36 | 100 | 4 |
| 10 | 0.36 | 0.36 | 100 | 124 |
| 11 | 0.36 | 0.36 | 100 | 124 |

These results show the rapid gel polymeric compositions of Examples 1, 3, 5 and 7 have a very short hydration time of the polymer or copolymer components versus the Examples 2, 4, and 6, which employ polymer components known in the art.

In one aspect, a rapid gel polymeric composition that exhibits a faster hydration time can be cost effective in lab scale and industrial scale. In the same amount of time, more final product can be produced. In another aspect, the composition can be applicable to continuous industrial productions. In another aspect, a composition as described herein does not produce any dust and does not require any dust collector equipment. In another aspect, a composition as described herein does not require the neutralization step mandatory for such products as described in U.S. Pat. Nos. 7,560,423 and 5,288,814.

In another aspect, the products of Examples 8 and 9 have a shorter preparation time, skipping completely the hydration time of the polymer or copolymer versus those of Examples 10 and 11, which employ polymer components known in the art.

It is understood that the disclosure provides rapid gel polymeric compositions and methods that can be used in a variety of applications and fields without limitation, such as all the industrial fields where a polymer above described is dispersed in water and/or solvent, for instance in cosmetic industry, pharmaceutics industry, coating industry, drilling fluid industry, agricultural, coatings and more.

Those skilled in the art will appreciate that many modifications and substitutions may be made to the foregoing description without departing from the spirit and scope of the present disclosure.

What is claimed:

1. A rapid gel polymeric system and composition, comprising:
a) a mixture for achieving rapid homogenous dispersion having a crosslinked or non-crosslinked acrylic acid homopolymers or copolymers component;
b) a suitable solvent component; and/or
c) a suitable organic or inorganic base component.

2. The rapid gel polymeric composition of claim 1, wherein a) is prepared in the following stages:
i dissolving the monomer or mixture of monomers, and the crosslinkers if any, in a suitable organic solvent, such as methylene chloride, benzene, low-boiling aliphatic hydro-carbons such as hexane or cyclohexane, lower esters such as methyl or ethyl acetate or mixtures of said solvents;
ii adding a polymerization initiator to the monomer or mixtures of monomers of i, wherein the polymerization initiators is selected from the group consisting of lauroyl peroxide, dicetyl peroxydicarbonate, benzoyl peroxide, or other peroxides;
iii heating ii at ambient pressure and at the temperature required by the nature of the monomers and polymerization initiators used, or at a pressure exceeding ambient pressure in a closed reactor, until polymerization of ii is complete;
iv evaporating the solvent until dry to obtain the polymer in the form of a fine powder easily dispersible in water; and
v separating the polymer of iv from the solvent by direct evaporation of the solvent or by filtration of the solvent and subsequent drying.

3. The rapid gel polymeric composition of claim 1, wherein component b) is an organic solvent readily soluble in water.

4. The rapid gel polymeric composition of claim 3, wherein the organic solvent is in the polyalkylene glycols family.

5. The rapid gel polymeric composition of claim 4, wherein the polyalkylene glycol is PEG at low molecular weight.

6. The rapid gel polymeric composition of claim 5, wherein the PEG is PEG300.

7. The rapid gel polymeric composition of claim 1, wherein component (c) is a inorganic base.

8. The rapid gel polymeric composition of claim 7, wherein the inorganic base is NaOH or KOH.

9. The rapid gel polymeric composition of claim 1, wherein component (c) is an organic base.

10. The rapid gel polymeric composition of claim 9, wherein the organic base is selected from the group consisting of monoethanol amine (MEA), dietahnol amine (DEA), triethanol amine (TEA), or aminomethylpropanol (AMP),), ammonia, or Tris(hydroxymethyl)aminomethane.

11. The rapid gel polymeric composition of claim 10, wherein the preferred organic base is AMP.

12. The rapid gel polymeric composition of claim 1, wherein a) is selected from the group consisting of homopolymers of acrylic acid, copolymers of acrylic acid with methacrylic, itaconic, maleic or crotonic acid, copolymers of acrylic acid with methyl, ethyl, propyl or higher esters up to C18-22, quaternary ammonium salt, and/or cationic branched alkyl of acrylic acid or of methacrylic, itaconic, maleic or crotonic acids, copolymers with other monomers containing a vinyl unsaturation, such as the vinyl esters of linear or branched acids up to C18-22, vinyl esters and styrene, crosslinked with ethylenically unsaturated multifunctional monomers such as the allyl ethers of pentaerythritol, trimethylolpropane or sugars.

13. The rapid gel polymeric composition of claim 7, wherein the inorganic base is NaOH.

14. The rapid gel polymeric composition of claim 7, wherein the inorganic base is KOH.

15. The rapid gel polymeric composition of claim 1, wherein b) is selected from the group consisting of organic ester, natural and mineral oils, polyglycerol fatty acid ester derivative, glyceril-esters, and triglycerides esters.

16. The rapid gel polymeric composition of claim 15, wherein component b) is an organic solvent not readily soluble in water.

17. The rapid gel polymeric composition of claim 16, wherein the organic solvent is organic ester, natural and mineral oils, polyglyceril-fatty acid ester derivative, glyceril-esters, triglycerides esters, hydrogenated paraffines, tall oil fatty acid (TOFA), PAG (poly-alkyl glycols), or PAO (poly-alpha olefins).

18. The rapid gel polymeric composition of claim 15, wherein the organic and inorganic base is selected from the group consisting of monoethanol amine (MEA), dietahnol amine (DEA), triethanol amine (TEA), or aminomethylpropanol (AMP),), ammonia, Tris(hydroxymethyl)aminomethane, KOH, or NaOH.

19. The rapid gel polymeric composition of claim 1, wherein the crosslinked or non-crosslinked acrylic acid homopolymers or copolymers component is present at 10% to 50% w/w.

20. The rapid gel polymeric composition of claim 19, where the crosslinked or non-crosslinked acrylic acid homopolymers or copolymers component is present at 10% to 20% w/w.

21. The rapid gel polymeric composition of claim 20, where the crosslinked or non-crosslinked acrylic acid homopolymers or copolymers component is present at 13% to 14% w/w.

22. The rapid gel polymeric composition of claim 15, wherein the crosslinked or non-crosslinked acrylic acid homopolymers or copolymers component is present at 10% to 70% w/w.

23. The rapid gel polymeric composition of claim 22, where the crosslinked or non-crosslinked acrylic acid homopolymers or copolymers component is present at 20% to 50% w/w.

24. The rapid gel polymeric composition of claim 23, where the crosslinked or non-crosslinked acrylic acid homopolymers or copolymers component is present at 13% to 14% w/w.
